(19) United States
(12) Patent Application Publication
(10) Pub. No.: US 2025/0294646 A1
(43) Pub. Date: Sep. 18, 2025

(54) CERAMIC HEATER

(71) Applicant: NITERRA CO., LTD., Nagoya-shi (JP)

(72) Inventors: Hiroki HATTORI, Nagoya-shi (JP); Hitoshi Furuta, Nagoya-shi (JP); Takumi Hosaka, Nagoya-shi (JP); Kazuki Tanizawa, Nagoya-shi (JP); Atsutoshi Sugiyama, Nagoya-shi (JP)

(73) Assignee: NITERRA CO., LTD., Nagoya-shi (JP)

(21) Appl. No.: 19/046,701

(22) Filed: Feb. 6, 2025

(30) Foreign Application Priority Data
Mar. 13, 2024 (JP) 2024-038707
Oct. 2, 2024 (JP) 2024-173157

(51) Int. Cl. H05B 3/18; C04B 35/10; C04B 41/50; C04B 41/86

(52) U.S. Cl. CPC H05B 3/18; C04B 35/10; C04B 41/5022; C04B 41/86; H05B 2203/021

(57) ABSTRACT

A ceramic heater 100 including: a ceramic body 10 including a heat generation resistor element 13; and a coat layer 20 formed mainly of glass and configured to cover at least corner portions 11E,12E of the ceramic body and a region including the heat generation resistor element, wherein ceramic particles 21 are adhered to at least a portion of a region of a surface of the coat layer where the coat layer covers the ceramic body.

### BACKGROUND

### 1. Field of the Disclosure

The present disclosure relates to a ceramic heater which is used for air conditioning of, for example, an electric vehicle, heating and temperature keeping of a battery, or the like.

### 2. Description of Related Art

There has been studied a system in which a medium such as a coolant liquid is heated with a ceramic heater for air conditioning of an electric vehicle or heating and temperature keeping of a battery. In particular, since the performance of the battery decreases in cold regions, heating and temperature keeping of the battery are important.

Such a ceramic heater has, for example, a structure in which a ceramic layer is wound around the outer periphery of a tubular or columnar ceramic tube serving as a core, and a heat generation resistor element having a predetermined heater pattern is formed in the ceramic layer (see Patent Document 1). When electricity is supplied to the heat generation resistor element, the ceramic heater generates heat.

Incidentally, since the ceramic heater is vulnerable to thermal shock, when the ceramic heater heated to a high temperature is rapidly cooled, there arises a possibility that a crack or the like is generated and the heater is broken.

In particular, in the case where a ceramic heater is used for heating a medium (fluid) such as coolant liquid, if a liquid droplet comes into contact with the ceramic heater in a state of heating without fluid (air heating state), a large thermal shock acts on the ceramic heater.

Meanwhile, as a method for protecting a ceramic member, it is conventionally known that glass (glaze) is applied to the surface of the ceramic member as in the technique of Patent Document 1 mentioned above.
[Patent Document 1] Japanese Patent Application Laid-Open (kokai) No. 2018-92880

However, when the glaze is fired at a high temperature, the viscosity of the glass material of the glaze lowers, and the glaze thickness tends to decrease, in particular, at corner portions of the object (ceramic heater). For this reason, the protection of the corner portions of the ceramic heater and thus the resistance to thermal shock may deteriorate.

As a countermeasure, it is possible to secure a sufficient glaze thicknesses at the corner portions by applying the glaze a plurality of times, but this is not practical, because it increases the man-hours, thereby increasing the cost.

### SUMMARY OF THE DISCLOSURE

In view of the above, an object of the present disclosure is to provide a ceramic heater which is prevented from breaking due to thermal shock.

### Means for Solving the Problem

In order to solve the above problem, a ceramic heater of the present disclosure is a ceramic heater having: a ceramic body including a heat generation resistor element; and a coat layer formed mainly of glass and configured to cover at least corner portions of the ceramic body and a region including the heat generation resistor element, wherein ceramic particles are adhered to at least a portion of a region of a surface of the coat layer where the coat layer covers the ceramic body.

In the case where the coat layer contains no ceramic particles, when the coat layer is fired at a high temperature, the viscosity of the glass material decreases, and the thickness of the coat layer of at least a portion of the ceramic body (corner portion and so on) decreases.

In view of the above, the ceramic particles are adhered to a region of the surface of the coat layer, where the thickness of the coat layer is small. Thus, the ceramic particles protect the portion where the thickness of the coat layer is small.

As a result, it is possible to mitigate thermal shock at the portion where the thickness of the coat layer is small, thereby preventing breakage of the heater due to thermal shock.

In the ceramic heater of the present disclosure, the ceramic body may be mainly formed of alumina, and the ceramic particles may be alumina particles.

According to this ceramic heater, since the components of the ceramic body are similar to those of the ceramic particles, the difference in the coefficient of thermal expansion between the ceramic body and the ceramic particles can be reduced, and thermal shock acting on the coat layer can be reduced.

In the ceramic heater of the present disclosure, the ceramic particles may be also adhered to a region of the surface of the coat layer, where the coat layer covers an outer circumferential surface of the ceramic body.

According to this ceramic heater, since the ceramic particles further protect the portion of the ceramic body which covers the heat generation resistor element and becomes hot, thermal shock acting on that portion can be mitigated.

In the ceramic heater of the present disclosure, the ceramic body may have the shape of a cylinder having an inner hole, the coat layer may further cover at least a portion of a wall surface of the inner hole, and the ceramic particles may be adhered to the surface of the coat layer which covers the wall surface of the inner hole.

According to this ceramic heater, since the ceramic particles protect the inner hole side of the ceramic body, thermal shock acting on that portion can be mitigated.

In the ceramic heater of the present disclosure, the ratio of coverage of the coat layer by the ceramic particles may be 88.5% or greater.

According to this ceramic heater, since the ceramic particles cover the greater part of the coat layer, and thus almost completely cover the corner portions of the ceramic body and the region including the heat generation resistor element, thermal shock can be further mitigated.

The present disclosure can provide a ceramic heater which is prevented from breaking due to thermal shock.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 is a front view of a ceramic heater according to an embodiment of the present disclosure.

FIG. 2 is a perspective view showing the configuration of a ceramic body.

FIG. 3 is a partial enlarged sectional view showing a coat layer containing no ceramic particles.

FIG. 4 is a partial enlarged sectional view showing a coat layer having ceramic particles adhered thereto.

### DESCRIPTION OF REFERENCE NUMERALS

Reference numerals used to identify various features in the drawings include, but are not limited to, the following:
10 ceramic body
10h through hole (inner hole)
11E, 12E, 13E portion of the to-be-covered region of the ceramic body (corner portion)
13 heat generation resistor element
20 coat layer
21 ceramic particle
100 ceramic heater
O axial-line

### DETAILED DESCRIPTION

Hereinafter, an embodiment of the present disclosure will be described.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus≤10% of particular term, and “substantially” and “significantly” will mean plus or minus >10% of the particular term.

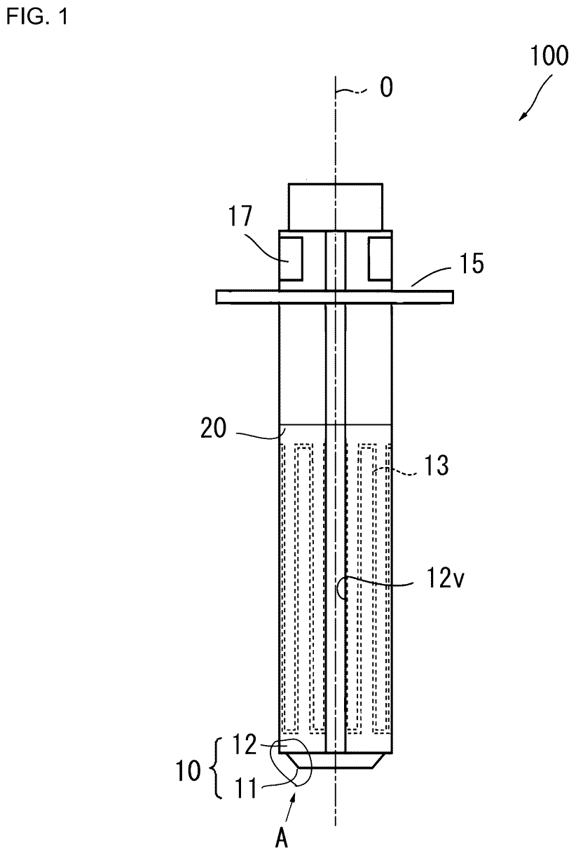

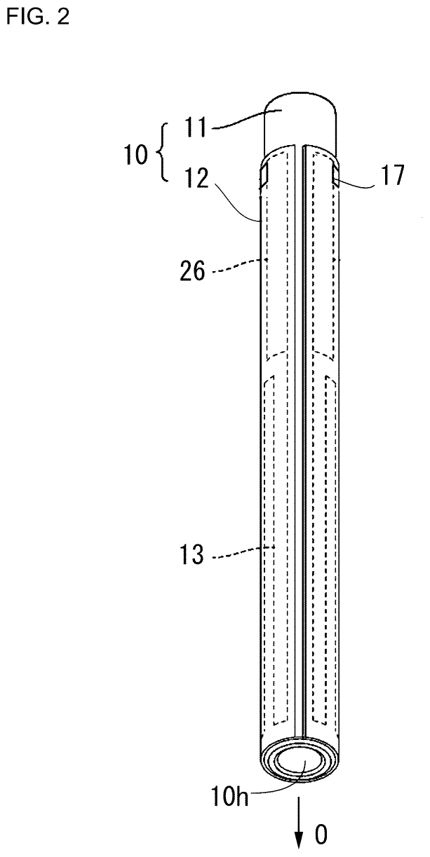

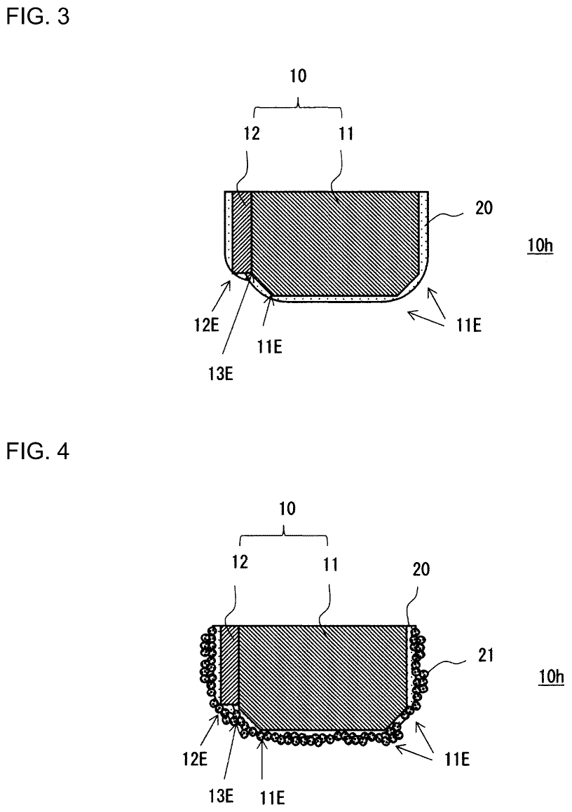

FIG. 1 is a front view of a ceramic heater 100 according to an embodiment of the present disclosure. FIG. 2 is a perspective view showing the configuration of a ceramic body 10. FIG. 3 is a partial enlarged sectional view showing a coat layer 20 containing no ceramic particles. FIG. 4 is a partial enlarged sectional view showing a coat layer 20 having ceramic particles 21 adhered thereto.

The ceramic heater 100 of this embodiment can be used for air conditioning of, for example, an electric vehicle, heating and temperature keeping of a battery, or the like. The ceramic heater 100 of this example is adapted for liquid heating and heats a liquid such as coolant liquid, thereby heating an object to be heated via the liquid.

As shown in FIG. 1, the ceramic heater 100 includes a ceramic body 10 having the shape of a circular column (or tube) and extending in an axial-line O direction, and a coat layer 20 mainly formed of glass and covering the surface of the ceramic body 10.

The heat generation resistor element 13 is embedded in the ceramic body 10.

The coat layer 20 is configured to cover at least a portion of the surface of the ceramic body 10 (e.g., corner portions 11E and 12E (see FIG. 3) and a region having the heat generation resistor element 13).

Here, the term “circular column” encompasses “cylinder.” In addition, the term “mainly” means that the amount of glass is greater than 50 mass % of the coat layer 20.

In the example of FIG. 1, sine the heat generation resistor element 13 extends, in the axial-line O direction, from the forward end of the ceramic body 10 toward the rear end side, the coat layer 20 extends, in the axial-line O direction, to cover a region of the ceramic body 10, the region extending from the forward end of the ceramic body 10 to a position on the rear end side of the heat generation resistor element 13.

Thus, the coat layer 20 protects a portion of the ceramic body 10 near the heat generation resistor element 13, which portion becomes hot due to heating, whereby thermal shock is mitigated.

Mitigation of thermal shock at the corner portions 11E and 12E will be described later.

A pair of external terminals 17 for supplying electricity to the heat generation resistor element 13 are exposed on the outer surface of a portion of the ceramic body 10 on the one end side (the rear end side).

An annular flange portion 15 formed of a ceramic material and used for attaching the ceramic heater 100 to an object (such as an electric vehicle), to which the ceramic heater 100 is to be attached, is fitted onto a portion of the ceramic body 10, which portion is located slightly forward of the external terminals 17. The flange portion 15 is fixed to that portion of the ceramic body 10 by glass or the like.

The coat layer 20 covers the outer surface of the ceramic body 10 on the forward end side of the flange portion 15.

The ceramic body 10 includes a ceramic tube 11 and a ceramic layer (ceramic sheet) 12 which covers almost the entirety of the outer circumference of the ceramic tube 11.

Since the ceramic layer 12 does not completely cover the outer circumference of the ceramic tube 11, a slit 12V extending in the axial direction (direction parallel to the direction in which an axial line L extends) is formed on the outer circumferential surface of the ceramic body 10.

In the present example, the ceramic body 10 has a cylindrical shape and has the through hole (inner hole) 10h at its center (FIG. 2). A liquid flowing inside the through hole 10h is heated by the ceramic heater 100, and the liquid on the outer peripheral side of the ceramic heater 100 is also heated by the ceramic heater 100.

As shown in FIG. 2, the heat generation resistor element 13 having a meandering shape and a pair of internal terminals 26 are formed on the inner circumferential surface (surface on the side toward the ceramic tube 11) of the ceramic layer 12 or are formed in the ceramic layer 12. The internal terminals 26 are electrically connected to the external terminals 17 at the end of the outer circumferential surface of the ceramic layer 12 through via conductors (unillustrated) or the like.

The heat generation resistor element 13 is disposed in a region near the forward end of the ceramic body 10, and the external terminals 17 are disposed on the rear end side of the ceramic body 10.

The ceramic tube 11 and the ceramic layer 12 may be formed of, for example, alumina.

Next, mitigation of thermal shock at the corner portions 11E and 12E by the ceramic particles 21 will be described with reference to FIGS. 3 and 4. Notably, in the present example, the corner portions 11E and 12E are shown as examples of the “at least a portion of the to-be-covered region of the ceramic body 10.” However, the to-be-covered region is not limited to the corner portions.

Notably, FIGS. 3 and 4 are partial enlarged sectional views of a forward end portion of the ceramic body 10 (region A of FIG. 1) taken along the axial-line O direction. Specifically, each of FIGS. 3 and 4 shows a region of the forward end of the ceramic tube 11 on one side (left side) with respect to the through hole 10h and a cross section of the ceramic layer 12 which covers the outer surface of this ceramic tube 11.

As shown in FIG. 3, of the surface of the ceramic body 10, at least the corner portions 11E and 12E and the region including the heat generation resistor element 13 are covered with the coat layer 20.

In the present example, the ceramic body 10 has a structure in which the ceramic layer 12 covers the ceramic tube 11 in such a manner that the ceramic layer 12 is wound around the outer circumference of the ceramic tube 11. Therefore, not only the corner portions 11E of the forward end of the ceramic tube 11 but also the corner portion 12E of the forward end of the ceramic layer 12 are exposed.

The “corner portions” are convex edges (end portions).

Notably, since the corner portions 11E are chamfered in the present example, the number of the corner portions 11E is generally four. Alternatively, in the case where the ceramic layer 12 covers the outer circumference of the ceramic tube 11 as shown in FIG. 3, the number of the corner portions is 5 (the case where the corner portion 12E overlaps one of the corner portions 11E in the axial-line O direction, and the corner portion in the overlap region is denoted by 13E).

In the case where the coat layer 20 contains no ceramic particles as shown in FIG. 3, when the coat layer (glaze) 20 is fired at a high temperature, the viscosity of the glass material decreases, and the thickness of the coat layer 20 decreases at the corner portions 11E and 12E.

In view of the above, as shown in FIG. 4, the ceramic particles 21 are adhered to a region of the surface of the coat layer 20, where the coat layer 20 covers at least partially the corner portions 11E and 12E. Thus, the ceramic particles 21 protect the corner portions 11E and 12E where the thickness of the coat layer 20 is small.

As a result, it is possible to mitigate thermal shock at the corner portions 11E and 12E, thereby preventing breakage of the heater due to thermal shock.

Notably, the ceramic particles 21 may be mixed and dispersed in a coating solution that becomes the coat layer 20. Then, after applying the coating solution containing the ceramic particles 21 to the ceramic body 10, firing is performed, whereby the coat layer 20 is formed, and the ceramic particles 21 adhere (stick) to the surface of the coat layer 20.

In addition, due to heat during firing, some ceramic particles 21 located adjacent to each other are bonded to each other.

In the case where, as in the present example, the ceramic body 10 is composed of a plurality of members (the ceramic tube 11 and the ceramic layer 12) and each member has corner portions, it is preferrable that the coat layer 20 covers at least partially all the corner portions (i.e., at least a portion of each corner portion) and the ceramic particles are adhered to at least a portion of each corner portion.

Examples of the material of the ceramic particles 21 include, but are not limited to, alumina-based ceramics, yttrian-based ceramics, aluminum nitride, silicon nitride, and silicon carbide, and combinations thereof.

However, in the case where the ceramic body 10 is mainly formed of alumina and the ceramic particles 21 are alumina particles, since the components of the ceramic body are similar to those of the ceramic particles, the difference in the coefficient of thermal expansion between the ceramic body and the ceramic particles can be reduced, and thermal shock acting on the coat layer can be reduced.

The average particle size (D50) of the ceramic particles 21 may be set to, for example, 1 to 100 μm, and is preferably 20 μm or greater.

The ceramic particles 21 may be also adhered to a region of the surface of the coat layer 20 where the coat layer 20 covers an outer circumferential surface of the ceramic body 10.

In this case, since the ceramic particles 21 further protect the portion of the ceramic body 10 which covers the heat generation resistor element 13 and becomes hot, thermal shock acting on that portion can be mitigated.

The ceramic body 10 may have the shape of a cylinder having an inner hole 10h, the coat layer 20 may further cover at least a portion of a wall surface of the inner hole 10h, and the ceramic particles 21 may be adhered to the surface of the coat layer 20 which covers the wall surface of the inner hole 10h.

In this case, since the ceramic particles 21 protect the inner hole 10h side of the ceramic body 10, thermal shock acting on that portion can be mitigated.

The area ratio of coverage of the coat layer 20 by the ceramic particles 21 may be 88.5% or greater.

In this case, since the ceramic particles 21 cover the greater part of the coat layer 20, and thus almost completely cover the corner portions 11E and 12E of the ceramic body 10 and the region including the heat generation resistor element 13, thermal shock can be further mitigated.

The above-mentioned coverage ratio (the ratio of coverage) may be calculated as follows.

First, an elemental mapping image of Si is obtained by EDS (energy dispersive X-ray analysis) (acceleration voltage: 15 Kev) on the surface of the coat layer 20 at the corner portions of the ceramic body 10. Then, this image is binarized, and image analysis is performed so as to obtain the area ratio of the region of the component (for example, Al) derived only from the ceramic particles 21 other than Si. The area ratio is regarded as the coverage ratio.

This is because the coat layer 20 is a glaze mainly formed of glass and contains SiO₂ and B₂O₃, while the ceramic particles 21 do not contain Si if they are formed of alumina (Al₂O₃), so the area ratio of the non-Si region is the area ratio of the region where the ceramic particles 21 cover the coat layer 20.

Therefore, the coverage ratio can be calculated by acquiring a mapping image of an element contained only in either the coat layer 20 or the ceramic particles 21 among the components of the coat layer 20 and the ceramic particles 21.

Notably, the area ratio is measured at three locations on the surface of the coat layer 20 measured by EDS, and their average is employed as the coverage ratio.

It should be understood that the present disclosure is not limited to the above embodiment and incorporates various modifications and equivalents within the idea and the scope of the present disclosure.

The coat layer is only required to cover at least a portion of the ceramic body, and it is sufficient to cover at least a portion of, for example, each corner portion (the corner portion may have a region where the coat layer is not formed).

The ceramic particles may completely cover the coat layer and form a layer.

The shape of the ceramic heater (the ceramic body) is not limited to the shape of a circular column, and may be a plate-like shape. Notably, in the case where the ceramic heater has a plate-like shape, since the ceramic heater has not only four corner portions on the forward end side but also four corner portions which form ridges and extend in the axial-line direction, the entire heater, from the heating generation portion to the rear end, may be coated.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2024-038707 filed Mar. 13, 2024 and Japanese Patent Application No. 2024-173157 filed Oct. 2, 2024, the disclosures of which are incorporated herein by reference their entirety.

What is claimed is:

1. A ceramic heater comprising:
a ceramic body including a heat generation resistor element; and
a coat layer formed mainly of glass and configured to cover at least corner portions of the ceramic body and a region including the heat generation resistor element,
wherein ceramic particles are adhered to at least a portion of a region of a surface of the coat layer where the coat layer covers the ceramic body.

2. A ceramic heater according to claim 1, wherein the ceramic body is mainly formed of alumina, and the ceramic particles are alumina particles.

3. A ceramic heater according to claim 1, wherein the ceramic particles are also adhered to a region of the surface of the coat layer, where the coat layer covers an outer circumferential surface of the ceramic body.

4. A ceramic heater according to claim 1, wherein
the ceramic body has the shape of a cylinder having an inner hole,
the coat layer further covers at least a portion of a wall surface of the inner hole, and
the ceramic particles are adhered to the surface of the coat layer which covers the wall surface of the inner hole.

5. A ceramic heater according to claim 1, wherein
an area ratio of coverage of the coat layer by the ceramic particles is 88.5% or greater.

6. A ceramic heater according to claim 2, wherein the ceramic particles are also adhered to a region of the surface of the coat layer, where the coat layer covers an outer circumferential surface of the ceramic body.

7. A ceramic heater according to claim 2, wherein
the ceramic body has the shape of a cylinder having an inner hole,
the coat layer further covers at least a portion of a wall surface of the inner hole, and
the ceramic particles are adhered to the surface of the coat layer which covers the wall surface of the inner hole.

8. A ceramic heater according to claim 2, wherein
an area ratio of coverage of the coat layer by the ceramic particles is 88.5% or greater.
